(19) United States
(12) Patent Application Publication
(10) Pub. No.: US 2009/0136734 A1
(43) Pub. Date: May 28, 2009

(54) UNIDIRECTIONAL RESIN INFUSED PANELS FOR MATERIAL CHARACTERIZATION TESTING

(75) Inventors: Thomas R. Berkel, Troy, IL (US); Panagiotis George, Lake Tapps, WA (US)

Correspondence Address: TUNG & ASSOCIATES, Suite 120, 838 W. Long Lake Road, Bloomfield Hills, MI, 48302, US

(73) Assignee: The Boeing Company

(21) Appl. No.: 11/944,760

(22) Filed: Nov. 26, 2007

(51) Int. Cl. B32B 9/04; B28B 1/00

(52) U.S. Cl. 428/292.1; 264/641

(57) ABSTRACT

A unidirectional resin infused panel. An illustrative embodiment of the unidirectional resin infused panel includes a plurality of laminated plies of a unidirectional fiber material each comprising a plurality of unidirectional reinforcing fibers. An unbound section is provided along the reinforcing fibers and generally free from fill-binding material. A first bound section having a fill-binding material is provided along the reinforcing fibers on a first side of the unbound section. A second bound section having a fill-binding material is provided along the reinforcing fibers on a second side of the unbound section. A cured resin is infused in the plurality of laminated plies of a unidirectional fiber material.

### TECHNICAL FIELD

The disclosure relates to panels used for material characterization testing. More particularly, the disclosure relates to unidirectional resin infused panels having sections which may lack secondary fill-binding material and are suitable for material property characterization testing.

### BACKGROUND

In the fabrication of composite materials, it may be necessary to utilize testing methods for material characterization such as to determine mechanical properties of the fabricated materials using Strain Invariant Failure Theory (SIFT) and/or other material property prediction methods. Unidirectional fiber which is used for material characterization testing may include fill-binding materials such as fill direction yarns, veils or thermofused filaments, for example and without limitation. These secondary fill-binding materials may impact basic physical material parameters such as fiber volume and resin density and may adversely affect the tensile, compression and shear test results for determination of strength, modulus and strain invariant properties. Therefore, unidirectional resin infused panels having sections or zones which lack secondary fill-binding materials may be useful for material characterization analysis in implementation of mechanical property prediction methods such as SIFT.

### SUMMARY

The disclosure is generally directed to a unidirectional resin infused panel. An illustrative embodiment of the unidirectional resin infused panel includes a plurality of laminated plies of a unidirectional reinforcing fiber material each comprising a plurality of unidirectional reinforcing fibers. An unbound section is provided along the reinforcing fibers and generally free from fill-binding material. A first bound section having a fill-binding material is provided along the reinforcing fibers on a first side of the unbound section. A second bound section having a fill-binding material is provided along the reinforcing fibers on a second side of the unbound section. A cured resin is infused in the plurality of laminated plies of a unidirectional fiber material.

The disclosure is further generally directed to a method of fabricating a unidirectional resin infused panel. An illustrative embodiment of the method includes providing a plurality of plies of dry unidirectional fiber material each including a plurality of unidirectional reinforcing fibers and first and second bound sections having a fill-binding material and an unbound section generally lacking the fill-binding material between the first and second bound sections; stacking the plurality of plies of dry unidirectional fiber material; infusing the plurality of plies of dry unidirectional fiber material with resin; and curing the resin.

The disclosure is further generally directed to a method of creating test specimens from a unidirectional resin infused panel. An illustrative embodiment of the method includes providing a unidirectional resin infused panel including first and second bound sections having a fill-binding material and an unbound section between the first and second bound sections and generally lacking the fill-binding material; identifying individual sections of the unidirectional resin infused panel to be tested; and cutting the unidirectional resin infused panel between the sections.

### BRIEF DESCRIPTION OF THE ILLUSTRATIONS

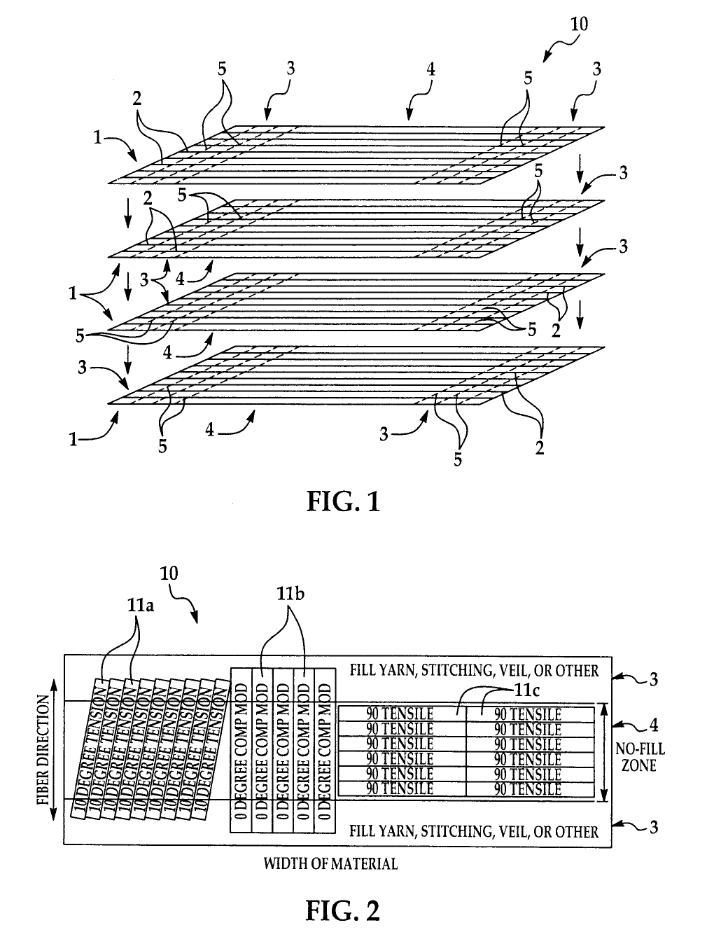

FIG. 1 is an exploded perspective view of an illustrative embodiment of a unidirectional resin infused panel.

FIG. 2 is a schematic diagram of a section of a unidirectional resin infused panel, more particularly illustrating multiple testing sections in the panel.

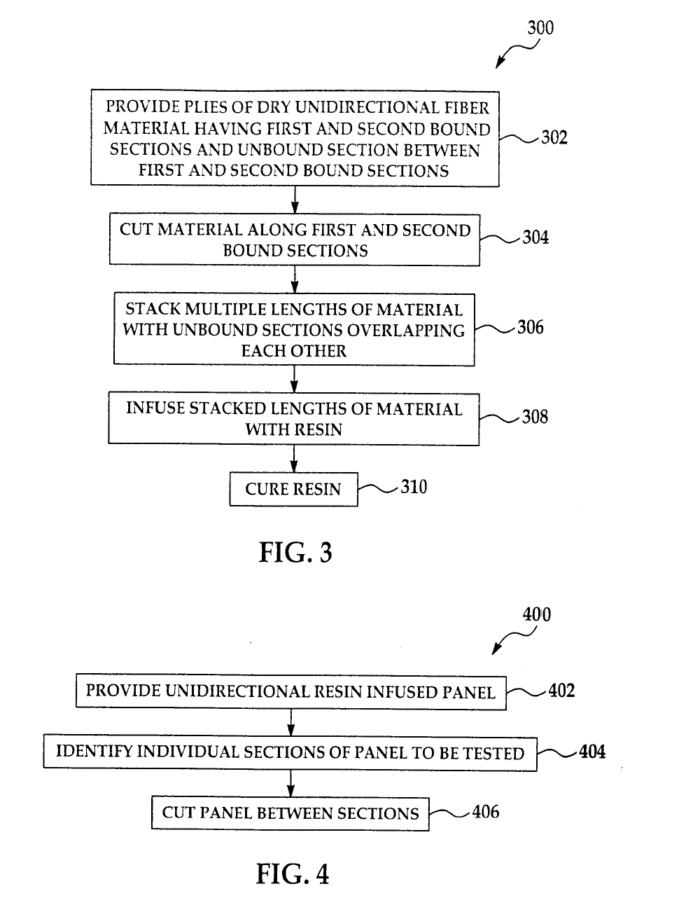

FIG. 3 is a flow diagram which illustrates an illustrative method of fabricating a unidirectional resin infused panel.

FIG. 4 is a flow diagram which illustrates an illustrative method of creating test specimens from a unidirectional resin infused panel.

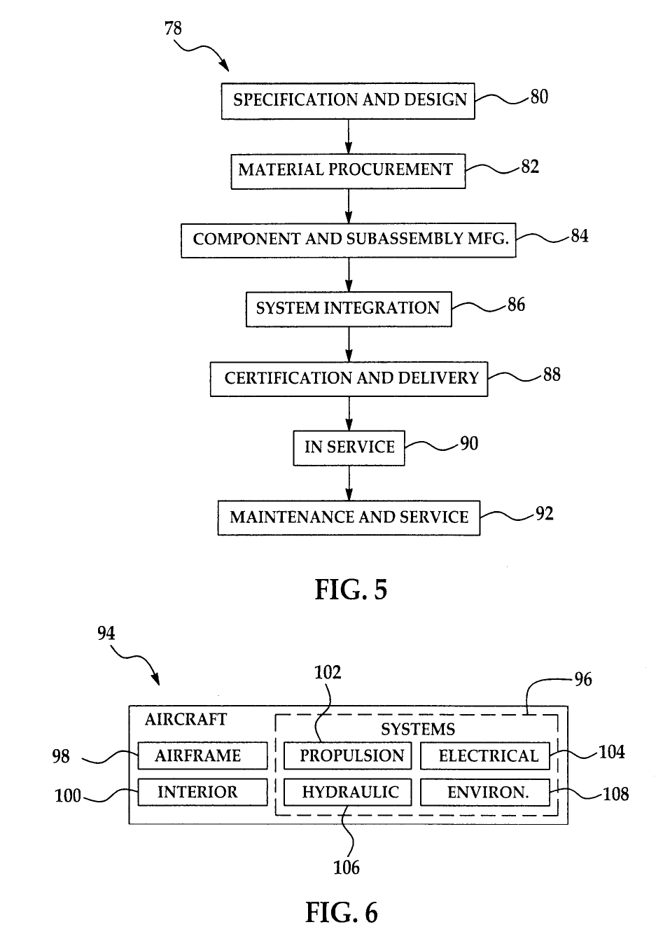

FIG. 5 is a flow diagram of an aircraft production and service methodology.

FIG. 6 is a block diagram of an aircraft.

### DETAILED DESCRIPTION

The disclosure is generally directed to unidirectional resin infused panels which are suitable for creating test specimens for material property characterization testing using such mechanical property prediction methods as Strain Invariant Failure Theory (SIFT), for example and without limitation. The unidirectional resin infused panels may be collated from multiple lengths of dry unidirectional fiber material including bound sections having fill-binding material and unbound sections which lack fill-binding material and extend between or alternate with the bound sections. Test specimens may subsequently be cut from the unbound sections of the panels for material characterization testing.

Referring initially to FIG. 1, an illustrative embodiment of a unidirectional resin infused panel is generally indicated by reference numeral 10. The unidirectional resin infused panel, hereinafter panel, may include multiple laminated plies of dry unidirectional fiber material 1. Each ply of dry unidirectional fiber material 1 may include multiple unidirectional reinforcing fibers 2 which may be oriented in generally parallel relationship with respect to each other and in generally parallel relationship with respect to a longitudinal axis 8 of the unidirectional fiber material 1. The unidirectional reinforcing fibers 2 may be uniformly-spaced with respect to each other.

Each ply of unidirectional fiber material 1 may include a pair of bound sections 3 and at least one unbound section 4 between the bound sections 3. A fill-binding material 5 may be provided in each bound section 3. The fill-binding material 5 may be glass fiber, thermofusable yarn, fill direction yarn, veils, stitches and/or any other suitable fill binder. The fill-binding material 5 may be oriented in generally perpendicular relationship with respect to the unidirectional reinforcing fibers 2. Each unbound section 4 may completely lack the fill-binding material 5. The bound sections 3 at respective ends of each unbound section 4 may facilitate handling of the unidirectional fiber material 1.

In some embodiments, the unidirectional fiber material 1 may include multiple bound sections 3 and multiple bound sections 4. The bound sections 3 may be disposed in spaced-apart relationship with respect to each other along the longitudinal axis 8 of the unidirectional fiber material 1. The unbound sections 4 may be disposed in spaced-apart relationship with respect to each other along the longitudinal axis 8 of the unidirectional fiber material 1 and may alternate with the bound sections 3. Therefore, each unbound section 4 may be flanked by a pair of bound sections 3.

The unidirectional fiber material 1 may be fabricated using any suitable technique which is known by those skilled in the art. In some fabrication methods, the unidirectional fiber material 1 may be fabricated on a conventional weaving loom (not shown) using fiber tows and spacing of the unidirectional fibers 2 which will provide the desired areal weight of the unidirectional fiber material 1. The unidirectional fibers 2 may be woven with the fill-binding material 5 across the full width of the unidirectional fibers 2 for the required length stabilization during panel molding along the longitudinal axis of the unidirectional fibers 2. The resulting fabric material may then be run through the weaving loom with no fill-binding material 5 for the length required for mechanical testing along the longitudinal axis of the unidirectional fibers 2. This sequence of alternating bound sections or zones with the fill-binding material 5 and unbound sections or zones without the fill-binding material 5 may be repeated any desired number of times to fabricate a selected yardage of the unidirectional fiber material 1 for use in test specimens, for example and without limitation. The fabrication process may be accomplished through the use of manual or pre-programmed means that stop and restart the fill-binding material 5 as required.

As shown in FIG. 1, a selected number of the plies of unidirectional fiber material 1 may be stacked to form the panel 10. While four plies of the unidirectional fiber material 1 form the illustrative embodiment of the panel 10 which is shown in FIG. 1, it will be appreciated by those skilled in the art that the panel 10 may have a greater or lesser number of the plies of unidirectional fiber material 1 depending on the desired thickness and application of the panel 10. In the panel 10, the unbound sections 4 of the stacked plies of unidirectional fiber material 1 may overlay each other. The stacked plies of unidirectional fiber material 1 may then be molded with liquid resin and cured.

Referring next to FIG. 2, a section of a unidirectional resin infused panel 10 having various test sections 11 which may be suitable for material characterization testing is shown. The test sections 11 may be cut from the unbound sections 4 of the unidirectional fiber material plies 1 which form the panel 10. The test sections 11 may include, for example and without limitation, tension testing sections 11a; compression testing sections 11b; and tensile testing sections 11c.

Referring next to FIG. 3, a flow diagram 300 which illustrates an illustrative method of fabricating a unidirectional resin infused panel is shown. In block 302, multiple plies of unidirectional fiber material having first and second bound sections and an unbound section between the first and second bound sections may be provided. In block 304, the plies of unidirectional fiber material may be cut along the first and second bound sections. In block 306, multiple plies of the unidirectional fiber material may be stacked with the unbound sections of the plies overlying each other. In block 308, the stacked plies of unidirectional fiber material may be infused with resin. In block 310, the resin may be cured.

Referring next to FIG. 4, a flow diagram 400 which illustrates an illustrative method of creating test specimens from a unidirectional resin infused panel is shown. In block 402, a unidirectional resin infused panel may be provided. In block 404, individual sections of the panel which are to be tested are identified. In block 406, the panel is cut between the sections which are to be tested to separate the sections from each other.

Referring next to FIGS. 5 and 6, embodiments of the disclosure may be used in the context of an aircraft manufacturing and service method 78 as shown in FIG. 5 and an aircraft 94 as shown in FIG. 6. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 6, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also, one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A unidirectional resin infused panel, comprising:
a plurality of laminated plies of a unidirectional fiber material each comprising:
a plurality of unidirectional reinforcing fibers;
an unbound section provided along said reinforcing fibers and generally free from fill-binding material;
a first bound section having a fill-binding material provided along said reinforcing fibers on a first side of said unbound section; and
a second bound section having a fill-binding material provided along said reinforcing fibers on a second side of said unbound section; and
a cured resin infused in said plurality of laminated plies of a unidirectional fiber material.

2. The unidirectional resin infused panel of claim 1 wherein said reinforcing fibers are generally equally-spaced with respect to each other.

3. The unidirectional resin infused panel of claim 1 wherein said fill-binding material comprises glass fibers.

4. The unidirectional resin infused panel of claim 1 wherein said fill-binding material comprises thermofusable yarn.

5. The unidirectional resin infused panel of claim 1 wherein said fill-binding material comprises fill direction yarn.

6. The unidirectional resin infused panel of claim 1 wherein said fill-binding material comprises veils.

7. The unidirectional resin infused panel of claim 1 wherein said fill-binding material is oriented in generally perpendicular relationship with respect to said reinforcing fibers.

8. A method of fabricating a unidirectional resin infused panel, comprising:
providing a plurality of plies of dry unidirectional fiber material each including a plurality of unidirectional reinforcing fibers and first and second bound sections having a fill-binding material and an unbound section generally lacking said fill-binding material between said first and second bound sections;
stacking said plurality of plies of dry unidirectional fiber material;
infusing said plurality of plies of dry unidirectional fiber material with resin; and
curing said resin.

9. The method of claim 8 wherein said stacking said plurality of plies of dry unidirectional fiber material comprises stacking said plies with said unbound section of each of said plies in generally overlying relationship with respect to said unbound section of others of said plies.

10. The method of claim 8 further comprising cutting said plies along said first and second bound sections.

11. The method of claim 8 wherein said fill-binding material comprises glass fibers.

12. The method of claim 8 wherein said fill-binding material comprises thermofusable yarn.

13. The method of claim 8 wherein said fill-binding material comprises fill direction yarn.

14. The method of claim 8 wherein said fill-binding material comprises veils.

15. The method of claim 8 wherein said reinforcing fibers are positioned in equally-spaced relationship with respect to each other.

16. A method of creating test specimens from a unidirectional resin infused panel, comprising:
providing a unidirectional resin infused panel including first and second bound sections having a fill-binding material and an unbound section between said first and second bound sections and generally lacking said fill-binding material;
identifying individual sections of said unidirectional resin infused panel to be tested; and
cutting said unidirectional resin infused panel between said sections.

17. The method of claim 16 wherein said cutting said unidirectional resin infused panel between said sections comprises cutting said unbound section of said unidirectional resin infused panel.

18. The method of claim 16 wherein said individual sections of said unidirectional resin infused panel to be tested comprises a plurality of tension testing sections.

19. The method of claim 16 wherein said individual sections of said unidirectional resin infused panel to be tested comprises a plurality of compression testing sections.

20. The method of claim 16 wherein said individual sections of said unidirectional resin infused panel to be tested comprises a plurality of tensile testing sections.
